(19) United States
(12) Patent Application Publication
(10) Pub. No.: US 2022/0063533 A1
(43) Pub. Date: Mar. 3, 2022

(54) DEPLOYABLE BARRIER FOR CROWD CONTROL VEHICLE AND ASSOCIATED CROWD CONTROL VEHICLE

(71) Applicant: STERLING WAYNE LOWERY, GLEN ALLEN, VA (US)

(72) Inventor: STERLING WAYNE LOWERY, GLEN ALLEN, VA (US)

(21) Appl. No.: 17/412,618

(22) Filed: Aug. 26, 2021

Related U.S. Application Data
(60) Provisional application No. 63/073,278, filed on Sep. 1, 2020.

(51) Int. Cl. B60R 19/38

(52) U.S. Cl. CPC B60R 19/38

(57) ABSTRACT

A deployable crowd control barrier comprises a first barrier wall and a second barrier wall, both adapted to be affixed to opposing sides of a vehicle. The first barrier wall comprises a first vertical pivot post adapted to be affixed to the vehicle and a first base wall portion pivotably affixed to the first pivot post. The second barrier wall comprises the second barrier wall comprising a second vertical pivot post adapted to be affixed to the vehicle and a second base wall portion pivotably affixed to the second pivot post. The first base wall portion is adapted to selectively pivot relative to the vehicle when the first barrier wall is affixed to the vehicle. The second base wall portion is adapted to selectively pivot relative to the vehicle when the second barrier wall is affixed to the vehicle.

### CROSS-REFERENCE TO RELATED APPLICATIONS

This application claims priority to pending U.S. Provisional Application Ser. No. 63/073,278, filed Sep. 1, 2020, the contents of which are incorporated herein by reference in its entirety.

### FIELD OF THE INVENTION

The present technology relates generally to crowd control vehicles.

### BACKGROUND OF THE DISCLOSURE

If you look up in Wikipedia “List of incidents of civil unrest in the United States”, you will find hundreds of incidents listed going all the way back to 1793. In fact, there are very few years that did not have incidents.

Unfortunately, the incidents have become more violent in recent years, with protestors becoming more aggressive—looting, setting fires and throwing objects at police officers, with over 400 serious injuries to officers just the summer of 2020.

In an effort to stop looting and destruction, officers set up a defense line, lining up in groups of 30 or more, to stop movement of crowds. While some of the protestors are peaceful, many throw rocks, frozen bottles, and all types of debris at the officers, one being hit in head by a fire extinguisher. The more aggressive protesters even get very close to the officers, right up within inches face to face and verbally abuse officers and try to antagonize the officers.

### BRIEF SUMMARY OF THE DISCLOSURE

In one embodiment of the invention, a deployable crowd control barrier comprises a first barrier wall and a second barrier wall. The first barrier wall is adapted to be affixed to a vehicle and comprises a first vertical pivot post adapted to be pivotably affixed to the vehicle and a first base wall portion affixed to the first pivot post. The second barrier wall is adapted to be affixed to the vehicle on an opposite side from the first barrier wall and comprises the second barrier wall comprising a second vertical pivot post adapted to be pivotably affixed to the vehicle and a second base wall portion affixed to the second pivot post. The first base wall portion is adapted to selectively pivot relative to the vehicle when the first barrier wall is affixed to the vehicle. The second base wall portion is adapted to selectively pivot relative to the vehicle when the second barrier wall is affixed to the vehicle.

The first base wall portion may be adapted to selectively pivot from an undeployed position abutting a first side of the vehicle to a deployed position that is pivoted up to 180 degrees from its undeployed position, and the second base wall portion may be adapted to selectively pivot from an undeployed position abutting a second side of the vehicle to a deployed position that is pivoted up to 180 degrees from its undeployed position.

The first barrier wall may further comprise a first telescoping wall portion affixed to and selectively slidably extendible from the first base wall portion, and the second barrier wall may further comprise a second telescoping wall portion affixed to and selectively slidably extendible from the second base wall portion. The first barrier wall may further comprise a first pivoting wall portion pivotably affixed to and selectively pivotable relative to a distal end of the first telescoping wall portion, and the second barrier wall may further comprise a second pivoting wall portion pivotably affixed to and selectively pivotable relative to a distal end of the second telescoping wall portion. The first telescoping wall portion may comprise (a) a plurality of top casters affixed along a top edge of the first telescoping wall portion and engageable with a top track affixed at a top edge of the first base portion and (b) a plurality of bottom casters affixed along a bottom edge of the first telescoping wall portion and engageable with a bottom track affixed at a bottom edge of the first base portion. The second telescoping wall portion may comprise (a) a plurality of top casters affixed along a top edge of the second telescoping wall portion and engageable with a top track affixed at a top edge of the second base portion and (b) a plurality of bottom casters affixed along a bottom edge of the second telescoping wall portion and engageable with a bottom track affixed at a bottom edge of the second base portion. The deployable crowd control barrier may further comprise a first roof portion extending at an angle from a top edge of the first base portion and a second roof portion extending at an angle from a top edge of the second base portion. The deployable crowd control barrier may further comprise a third roof portion extending at an angle from a top edge of the first telescoping wall portion and a fourth roof portion extending at an angle from a top edge of the second telescoping wall portion. The first roof portion and the third roof portion may be nested when the first telescoping wall portion is not slidably extended from the first base wall portion, and the second roof portion and the fourth roof portion may be nested when the second telescoping wall portion is not slidably extended from the second base wall portion.

The first base wall portion may comprise a movable bumper selectively movable downward to a position extending below a bottom edge of the first base wall portion and upward to a position not extending below a bottom edge of the first base wall portion, and the second base wall portion may comprise a movable bumper selectively movable downward to a position extending below a bottom edge of the second base wall portion and upward to a position not extending below a bottom edge of the second base wall portion.

The deployable crowd control barrier may further comprise a first supporting cable affixed at a proximal end to the pivot post and at a distal end to a distal end of the first base wall portion and a second supporting cable affixed at a proximal end to the pivot post and at a distal end to a distal end of the second base wall portion.

In alternative embodiments of the invention, a crowd control vehicle comprises a vehicle body having a first side and an opposing second side and a deployable crowd control barrier as described above affixed to opposing sides thereof.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 shows perspective side views of our right and left barriers shown attached to the side of a bus.

FIG. 2 is a rear view of our barriers sandwiched above the bus for transport to site.

FIG. 3 shows the underside of the bus and our attachment secured to the bus frame and our left and right barriers opened 90 degrees.

FIG. 4 shows side view of the bus with barriers extended out 90 degrees off side of the bus.

FIG. 5 shows the top of the bus with main barriers with roofs opened 90 degrees and the inner second barriers with roofs extended out fully from within the main barriers.

FIG. 6 shows the rear of the bus and the rear of the main barriers opened 90 degrees and the rear of the inner barriers extended out fully.

FIG. 7 shows the front of the bus and the front side of the main barriers opened 90 degrees and the front of the inner barriers extended fully.

FIG. 8 shows back side of bus with barriers extended.

FIG. 9 shows rear view with another view of the roofs.

FIG. 10 shows front view of the bus and view of the roofs.

FIG. 11 shows view of the right main barrier and the inner barrier extended—leaving 25% of the inner barrier structure and casters within the main barrier main frame to help support the extended 75%.

FIG. 12 shows the plan view of the bus with the main barrier and inner barriers extended left and right and a third barrier that attached to the end of the inner barrier which lays parallel to the inner barrier and attached to another pivot post allowing it to swing 270 degrees off the inner barriers side.

FIG. 13 shows an expanded view of the third barrier and how it lays parallel on backside of the inner barrier and attached to the rotary actuator pivot post and opening.

FIG. 14 shows the bus and the barriers opening at various degrees all the way open to 180 degrees and the third barrier opening 230 degrees of its possible 270 degrees.

FIG. 15 shows the barriers attached to a fully shielded skid steer loader for mobility and attached to pivot post mounted on front corners with a barrier on front face of the barriers and the front of the rectangular total shield encasement.

FIG. 16 shows plan view of the fully shielded skid steer loader with right main barrier opened 90 degrees and left main and inner barriers in closed position showing water hose reel on rear within the shield for firefighting.

FIG. 17 shows plan view of the fully shielded skid steer loader with the right barriers opening to various degrees from parallel to the side of the shield—showing it at 90 degrees, 180 degrees, and up to 270 degrees.

FIG. 18 shows bumper in up position on face of main barrier.

FIG. 19 shows our system attached to a bus in a typical major intersection in a city.

FIG. 20 shows our system attached to a skid steer loader with its main barriers opened 90 degrees, our extended barriers extended and our swinging barrier opened, pulled up to a curb in a city.

### DETAILED DESCRIPTION OF THE DISCLOSURE

Certain terminology is used in the following description for convenience only and is not limiting. The words “lower,” “bottom,” “upper,” “top,” and the like designate directions in the drawings to which reference is made. The words “inwardly,” “outwardly,” “upwardly,” “downwardly,” and the like refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

In an effort to try to separate the officers and offer some protection when the incidents become violent, we have designed a mobile barrier that will separate the officers from the protestors and provide a mobile “movable” shield and/or an option to the vertical shield—having a roof that is horizontally or near horizontally attached to the vertical shield to keep officers protected from being pelted with rocks, frozen bottles, debris etc. thrown over the vertical shield.

The mobile barrier and/or barrier with roof will separate the officers and protestors, potentially keeping protestors from getting hostile and getting into trouble.

The barrier may have a number of options including, but not limited to, spray nozzles embedded along the face and have ability to spray various options the police departments can incorporate when the barrier is built, including foul odors, tear gas, color spray stains, etc.

In front of the vehicle and on front faces of the barrier, there may be heavy-duty plastic traffic barriers that can be lowered to ground level, that may be used to prod the protestors to move back as the mobile barrier is moving forward—directing the protestors as desired.

The barrier system may have a loudspeaker system allowing an officer in a control booth to warn protestors before using sprays or other options, when protestors get too close to the barrier or not moving as barrier is being moved closing off areas.

The barrier system may have photographic and video camera options and video or photograph the protestors as they are legally protesting or being asked to move. The cameras may be high enough elevation to video aggressive people behind others that may use the peaceful protesters in front to hide themselves then throw items at the police from the rear.

An additional option may be offered to keep the protestors back several feet from the barrier, and help them back-up, that being an electrified area along the face and/or a bumper that may give a slight shock using cattle fencing technology. Signs along face may warn the protestors they may receive the voltage and hopefully encourage them to move backwards as the whole barrier is moved forward as needed. Obviously, this will be provided only if the law enforcement feels comfortable applying it and it being lawful to do so. There may be option to have an extended bumper out several feet off the face that could be electrified.

The barrier system may have flood lights illuminating the areas around the barriers and beyond. It may have spotlights that can be directed at certain areas of protestors, by an officer in the control booth, to help take video or photos of the aggressive troublemakers.

We will offer a mobile barrier that may be remote controlled, we call “The Intimidator” that can be sent into a very violent area where looting and very aggressive behavior has started and is too intense for officers to advance into, including remote firefighting capabilities. This option is described further below.

The mobile barrier can be attached to a tractor, truck, van, or trailer, and even a bus and our “Intimidator” can be attached to a mobile skid steer. All of the vehicles to which the deployable crowd control barriers of embodiments of the invention may be attached are collectively referred to herein as “vehicles,” which may be motorized or non-motorized. The barriers can be attached to the front corner of the vehicle and swing out to either side—more than tripling the width of the vehicle on each left or right sides. And the barriers can be attached to the sides of the vehicle and extend out four or more times the width of the vehicle it is attached to for mobility.

The barrier has a left and right pivot post. The barriers may be attached to the pivot post and may be opened either manually or in most cases hydraulically, pivoting from the side of the mobile vehicle approximating 90 degrees to its normal open position. By using a common rotary actuator, it can be opened as much as 180 degrees if pivoting of the sides of the vehicle behind the front wheel well or as much as 270 degrees if pivoting off the front corners. Either the right or left barrier can be opened independently or simultaneously. The barriers may be any suitable height, typically seven to ten feet high, dictated by the height of the vehicles they are attached to, and the length may be the approximate length of the vehicles or a little more. The barrier can have a roof attached if desired by the customer. Most customers will likely want that option. The barrier can be optionally constructed of a simple chain link fence, all the way up to heavy-duty bullet proof steel and bullet proof glass, or any suitable material. The first (proximal) portion of the barrier (which may be termed a base wall portion) would typically be constructed of light square aluminum or steel tubing, light gauge plate steel and heavy plastic viewing portals.

Attached to the base wall portion, there may be a second barrier (which may be termed a telescoping wall portion), that can be extended manually, or mechanically, and we envision most wanting hydraulically extended. A swing barrier (which may be termed a pivoting wall portion) may be offered as an option as well, attached to the distal end of either the base wall portion or the telescoping wall portion. The pivoting wall portion may be attached to the end of the base wall portion or the telescoping wall portion and extended either before or after the telescoping wall portion is extended. The swing barrier can be manually or hydraulically extended. The swing barrier may have the option of having a rotary actuator that can turn the barrier from parallel against the first or second barrier up to 350 degrees, typically 90 degrees off the face of the base wall portion. The swing barrier may have option of having a roof and having an additional rotary actuator to open the roof. This will be of more interest on our Intimidator model as it can be used to protect a breached store front or protect a store front before it is breached, as the barrier is attached directly to the front of that unit (i.e., it does not have a cab out front), and it can pull up within inches of the face of the building and extend the barriers. Having that extra wing will give the Intimidator the ability to extend around the corner of the building. If there is a sidewalk and fire hydrants, light poles, etc. present that prevent the unit from pulling up on the sidewalk, the Intimidator could set up at the curb and the wings could potentially extend out 90 degrees across the sidewalk to the face of the building either protecting it from being breached or contain those within who are inside the breached building.

The second deployable barrier that can be attached to the opposing side of the vehicle and opened to the left will typically have the same features.

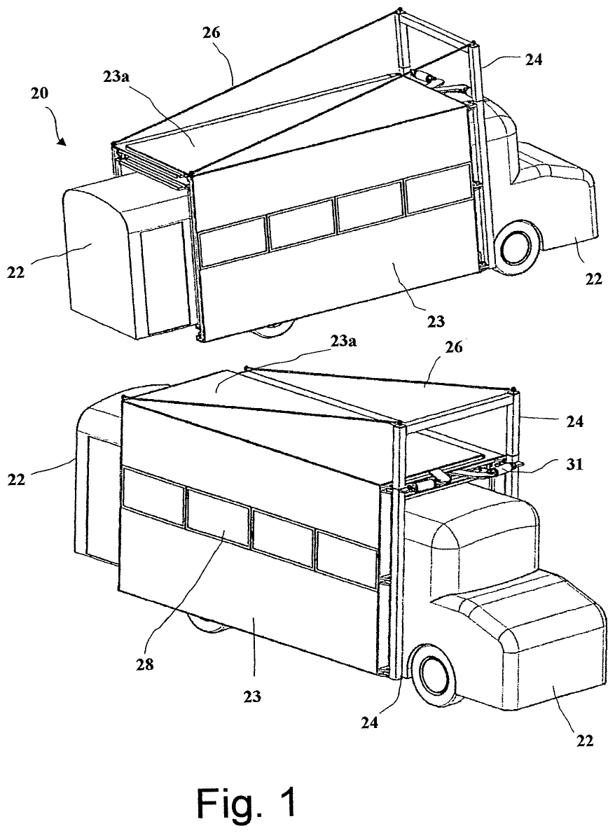

With reference to FIG. 1 there is shown first embodiment of a mobile barrier system 20 comprising a first barrier wall attached to the right side of a vehicle 22 according to the present invention and a second barrier wall attached to the left side of the vehicle 22. The mobile barrier system 20 can be attached to a bus 22 shown herein, or a van, truck, trailer, tractor, skid steer or any vehicle for mobility. The first barrier wall, which is attached to the vehicle 22 via a pivot post 24 that is pivotably affixed to the vehicle 22, comprises a first base wall portion 23 affixed to the pivot post 24. As seen in the figures, there are two pivot posts 24, one affixed to each side of the bus 22, Each pivot post 24 may be affixed to the vehicle 22 using any suitable attachment mechanism, such as a bracket (not illustrated) affixed to the roof of the vehicle 22 and a bracket (not illustrated) affixed to the main chassis frame 21 under the vehicle 22. A brace or bracket (not illustrated) may connect the two pivot posts to each other for additional rigidity and security. The pivot post 24 can be rotated by hydraulic cylinders 31 or hydraulic rotary actuator 32 (seen in FIGS. 12-14 for a different purpose) attached to the pivot post 24. Either may allow the barriers to be opened to various degrees from parallel to the side of the vehicle to a desired degree of rotation away from the side of the vehicle and stopped and/or reversed.

Similarly, the second barrier wall is attached to the left side of the vehicle 22 via a pivot post 24 that is pivotably affixed to the vehicle 22 and comprises a second base wall portion 24 affixed to the pivot post 24.

Tension cable 26, which may be for example either be a wire rope or a chain) are affixed at the top of each pivot post 24 and attached at outer end top corner of a respective base wall portion 23 or 27 to help support the weight of the respective barrier wall. The front of bus 22 or vehicle the mobile barrier is attached to can be shielded with steel plate and safety glass windshield. The windows 28 on the barriers can be plexiglass or bullet proof glass. The barrier face can be anything from a strong tarp, to steel, to steel with Kevlar shield on back of steel, to very heavy bullet proof steel.

The first barrier wall further comprises a first telescoping wall portion 25 affixed to and selectively slidably extendible from the first base wall portion 23, and the second barrier wall further comprises a second telescoping wall portion 29 affixed to and selectively slidably extendible from the second base wall portion 27. Casters 35 are attached to tops and bottom of telescoping wall portions 25 and 29 to allow each to be extended. The caster 35 engage with a corresponding bottom channel or track 62 and top channel or track 63 at the bottom and top edges, respectively, of the respective base wall portions 23 and 27.

Any or all of the wall portions may have a roof portion that that is horizontally or near horizontally attached to the vertical shield to keep officers protected from being pelted with rocks, frozen bottles, debris etc. thrown over the vertical wall portions. In the figures, first base wall portion 23 has a corresponding roof portion 23a; first telescoping wall portion 25 has a corresponding roof portion 25a; second base wall portion 27 has a corresponding roof portion 27a; and second telescoping wall portion 29 has a corresponding roof portion 29a. The roof portions are preferably horizontal to their respective wall portions to allow the roof portions to nest as described immediately below.

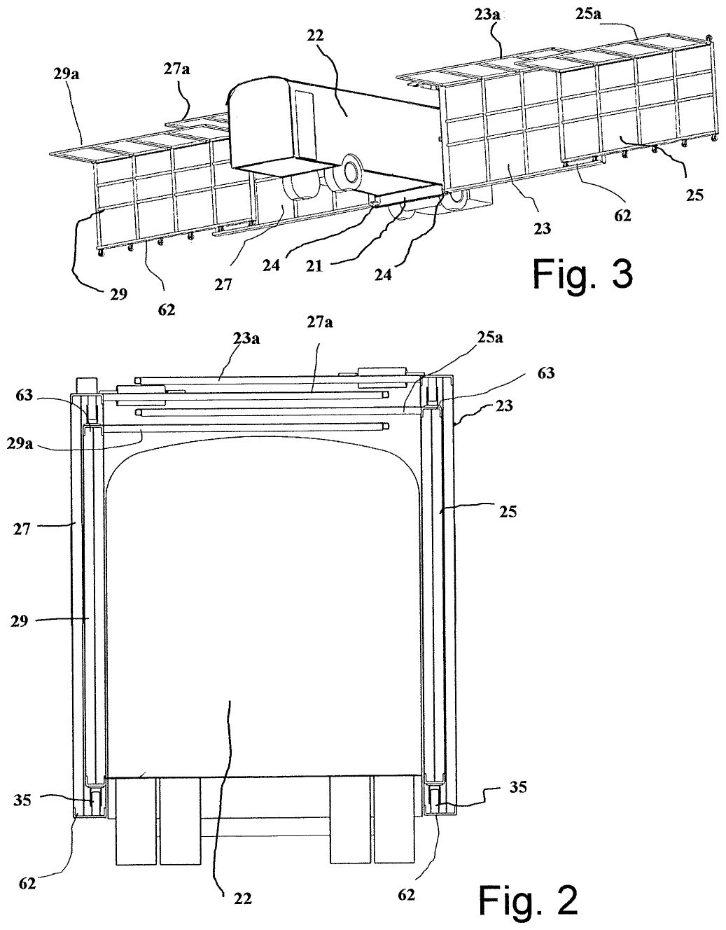

When the telescoping wall portions 25, 29 are not extended from their respective base wall portions 23, 27, the roof portions 23a and 25a nest and the roof portions 27a and 29a nest. As shown in FIG. 2 all of the roof portions 23a, 25a, 27a, 29a of the barrier sections are sandwiched or nested above the bus/vehicle 22 on top for mobility to the site. Looking at the rear of bus 22, barriers 23 and 25 are on the right side and barriers 27 and 29 are located on the left side.

As shown in FIG. 3 looking at the rear of bus 22 and under bus 22, the barriers 23 and barrier 25 have been opened 90 degrees to the right and barriers 27 and barrier 29 have been opened and extended to the left 90 degrees. The pivot post 24 on the right and pivot post 24 on the left are both attached to the main frame 21 of the bus 22.

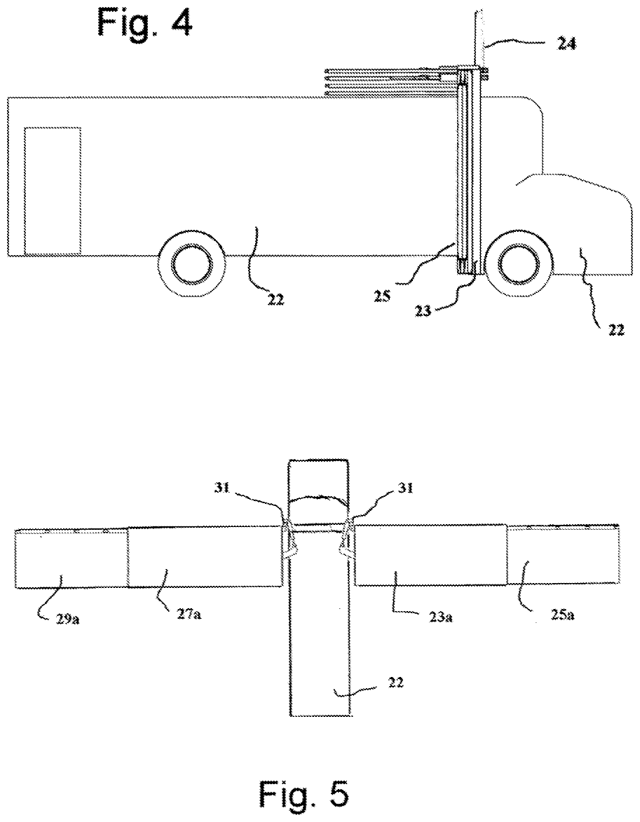

As shown on FIG. 4 is a right side view of the bus 22 with the barriers 23 and 25 extended 90 degrees off the side of the bus 22. It shows pivot post 24 which may have wire rope or chain out to the end corner of 23 and 27 to help support weight.

With reference to FIG. 5 shown is the top view of bus 22 with barriers 23 and 25 to the right and barriers 27 and 29 opened 90 degrees off the sides of bus 22. It shows hydraulic cylinder 31 opening the barriers. Hydraulic rotary actuators could be used to turn the pivot post as well.

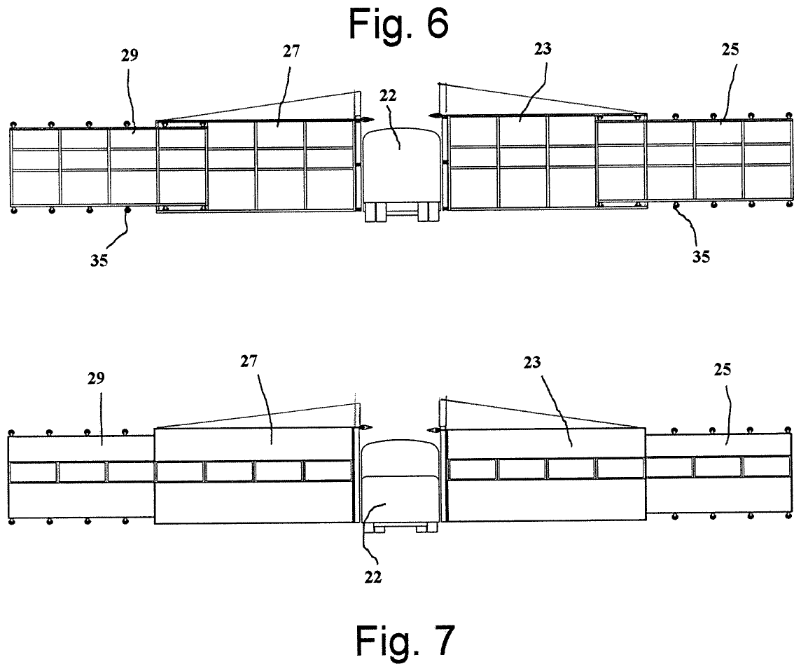

As shown in FIG. 6 is a rear view of bus 22 with barriers 23 and 25 on right in 90 degree open position and barriers 27 and 29 on right in 90 degree open position. As barrier 25 and 29 are extended, casters 35 guide them out while leaving approximately 25% within frame of barriers 23 and 27 when fully extended to support suspension of barriers 25 and 27.

FIG. 7 shows front view of the bus 22 with barriers 23 and 25 and barriers 27 and 29 opened to 90 degree position.

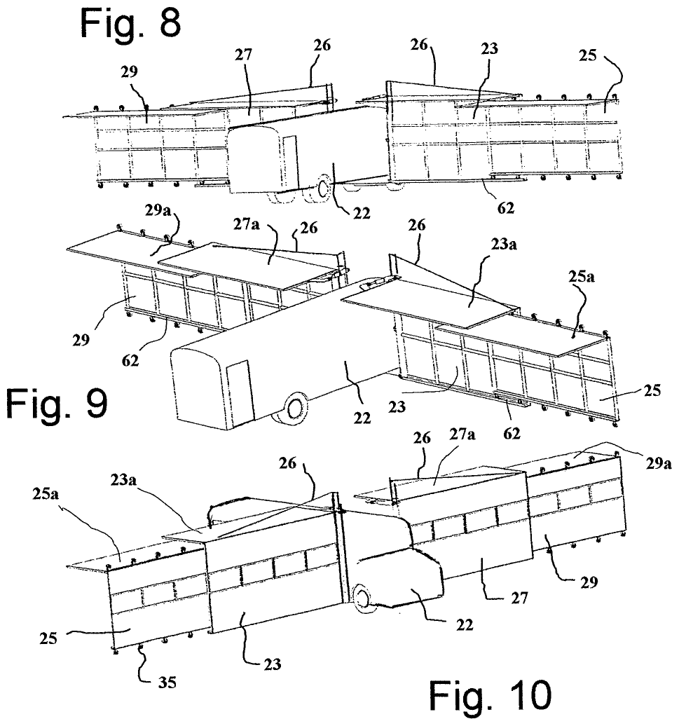

FIG. 8, FIG. 9, and FIG. 10 show bus 22 in three different positions to show the roof portions 23a, 25a of barriers 23 and 25 and the roof portions 27a, 29a of barriers 27 and 29 from various viewpoints.

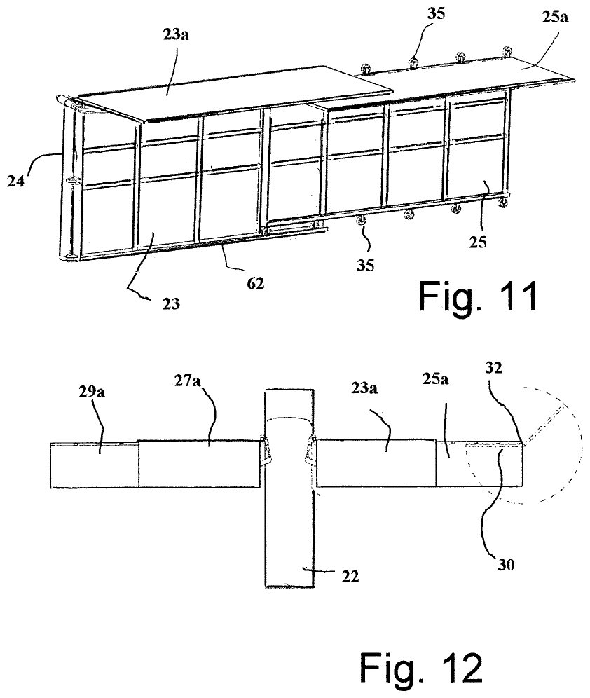

With reference to FIG. 11 shown is the rear side of the right base wall portion 23 with the telescoping wall portion 25 extended out about 75%, leaving casters 35 at bottom and top guided within channels 62, 63, respectively, at the bottom and top of base wall portion 23 to support the extended weight of telescoping wall portion 25.

Shown in FIG. 12 is a plan view of bus 22 with the right barrier wall having a swinging or pivoting wall portion 30 that can be pivotably mounted to the distal ends of the base wall portions 23, 27 (not illustrated) or the distal ends of the telescoping wall portions 25, 29 (only 25 is illustrated. Pivoting wall portion 30 may be pinned or otherwise affixed to pivot post 32. Pivoting wall portion 30 may be rotated from an undeployed position behind and abutting the telescoping wall portion 25, via pivot post 24 powered by a rotary actuator 32 capable of turning the swinging barrier up to 360 degrees (however in most cases 180 degrees up to 270 degrees).

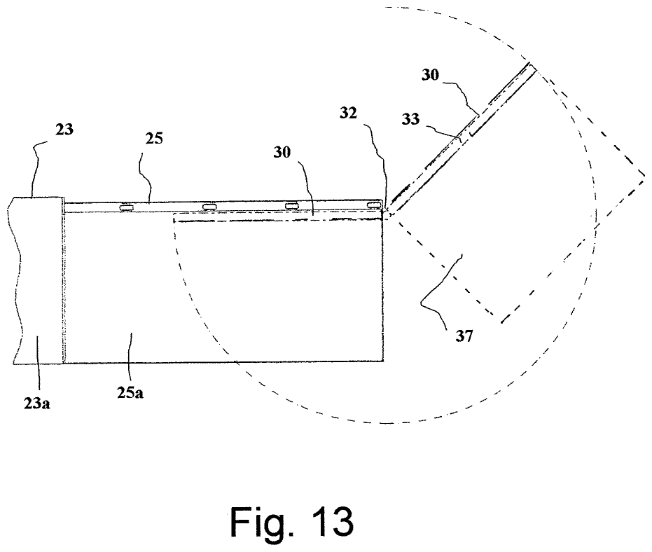

FIG. 13 is an expanded view of pivoting wall portion 30 shown swung open 210 degrees by rotary actuator 32 on vertical pivot post 32 and shown with an optional movable roof 37 that may be raised from vertically hanging down once the pivoting wall portion 30 is opened 90 degrees (if the telescoping wall portion 25 does not have a roof) or 180 degrees (if, as illustrated, the telescoping wall portion 25 has a roof portion 25a). The roof portion 37 is raised by a rotary actuator 33 on top of pivoting wall portion 30. To close roof portion 37 behind swinging barrier 30 once swinging barrier is reversed to its 90 or 180 degree position (as appropriate), the rotary actuator 33 may pivot the roof portion 37 down behind pivoting wall portion 30 so the pivoting wall portion 30 can be closed parallel to the barrier wall to which it is attached. The pivoting wall portion 30 can be as long as the barrier wall to which it is attached. If pivoting wall portion 30 is attached to the base wall portions 23 on right or 27 on the left, the telescoping wall portions 25 or 29 would not be needed. Rotary actuators can be built to turn pivoting wall portion 30 any degree up to 360 degrees.

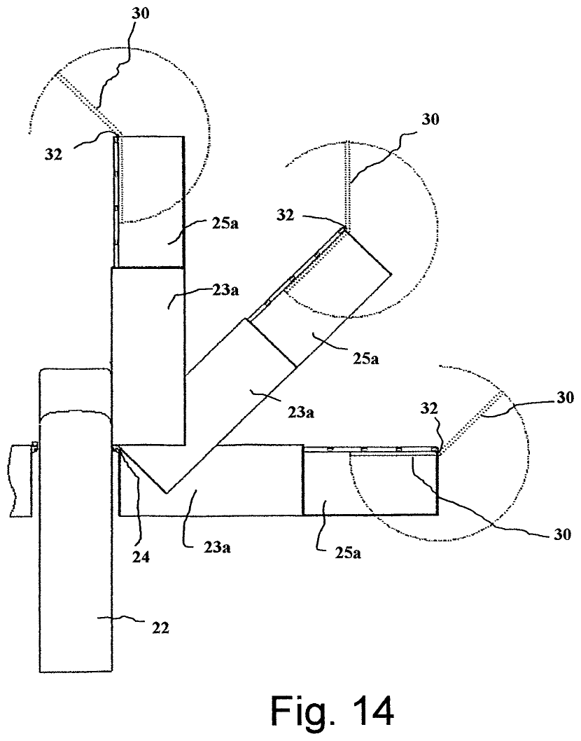

Shown on FIG. 14 is a plan view of bus 22 with right wall portions 23 and 25 and pivoting wall portion in three open positions of 90 degrees and 135 degrees and fully opened to 180 degrees. FIG. 14 also shows the pivoting wall portion 30 rotated 112 degrees relative to the telescoping wall portion 25 to which it is attached by rotary actuator pivot post 32.

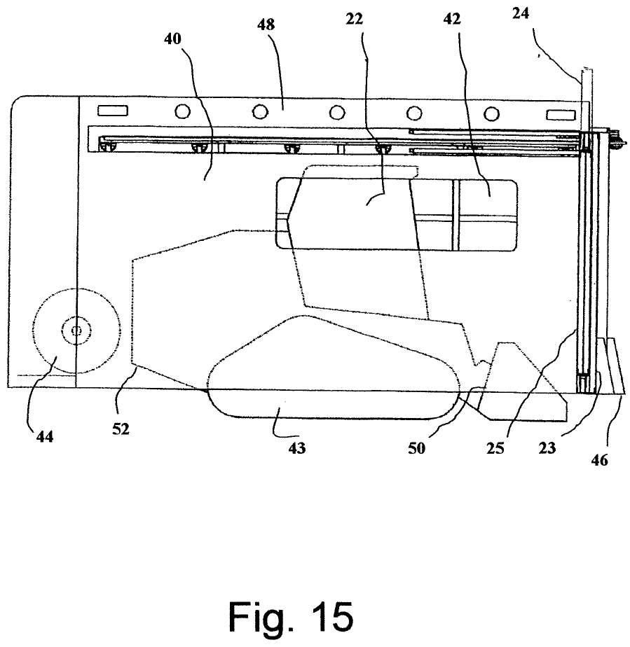

With reference to FIG. 15, a side view of the mobile barriers of embodiments of the invention is shown attached to another vehicle for mobility. The vehicle illustrated is a common skid steer loader 42, which can be remote controlled, encased within a steel shield 40, our barriers attached to the front 50 and rear corners 52, and showing right barriers 23 and 25 opened 90 degrees. The skid steer 42 shown is on crawlers 43 for mobility and could be on wheeled version for mobility as well. Within the shielded area there can be a water hose reel 44 mounted to lay down a water hose as it moves into a risky area and pick it back up automatically as it reverses. Plexiglass or bullet proof glass windows 28 may be provided on all four sides for visibility if operated by an individual if needed. Above the barriers over the shielded area may be a boxed trough 48 for flood lights, spotlights, video cameras, speakers, firefighting water nozzles and other options. In front is shown a bumper 46 that can be lowered to ground elevation and raised back up for transportation. Also shown is top of pivot post 24 to support wire rope or chain (not visible) to support weight out at barrier 23 or 27 ends.

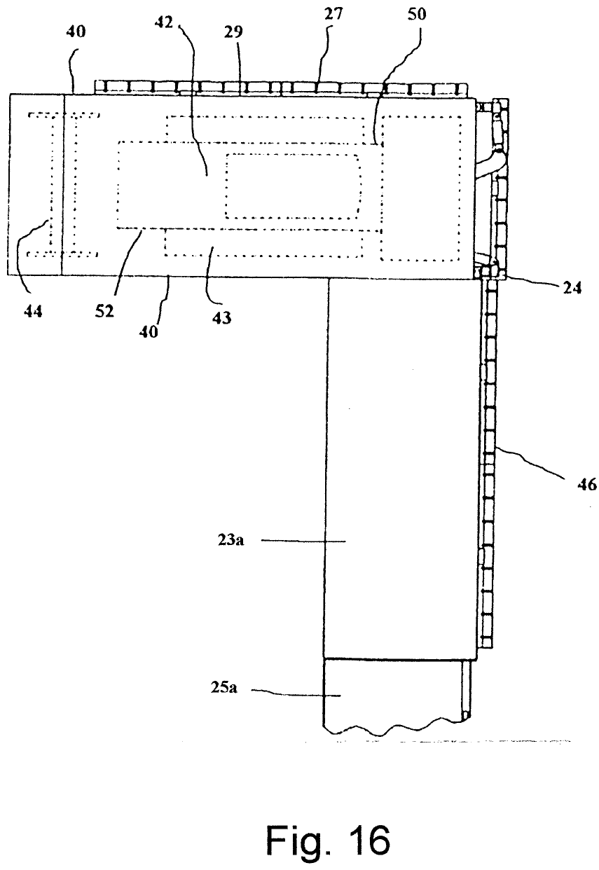

Shown in FIG. 16 is a plan view of the shield 40 over the skid steer loader 42 showing main right barrier 23 and 25 opened to 90 degrees with left barriers 27 and 29 closed. The shield can be attached to the skid steer standard quick coupler 50 at front where a bucket would normally attach to the skid steer loader, and brackets 52 at rear so the shield 40 can quickly disconnect and back out from under the shield 40 and be used for other purposes when not needed to carry the shield and barriers.

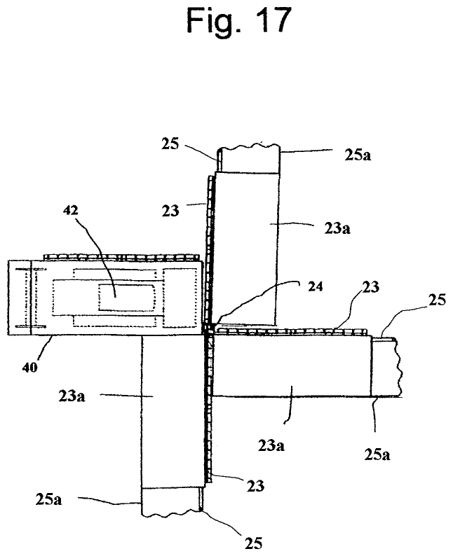

With reference to FIG. 17 shows plan view of the shield 40 over the skid steer with barriers 23 and 25 opened to various degrees pivoting by rotary actuator post 24 to 90 degrees, 180 degrees, and fully opened at 270 degrees.

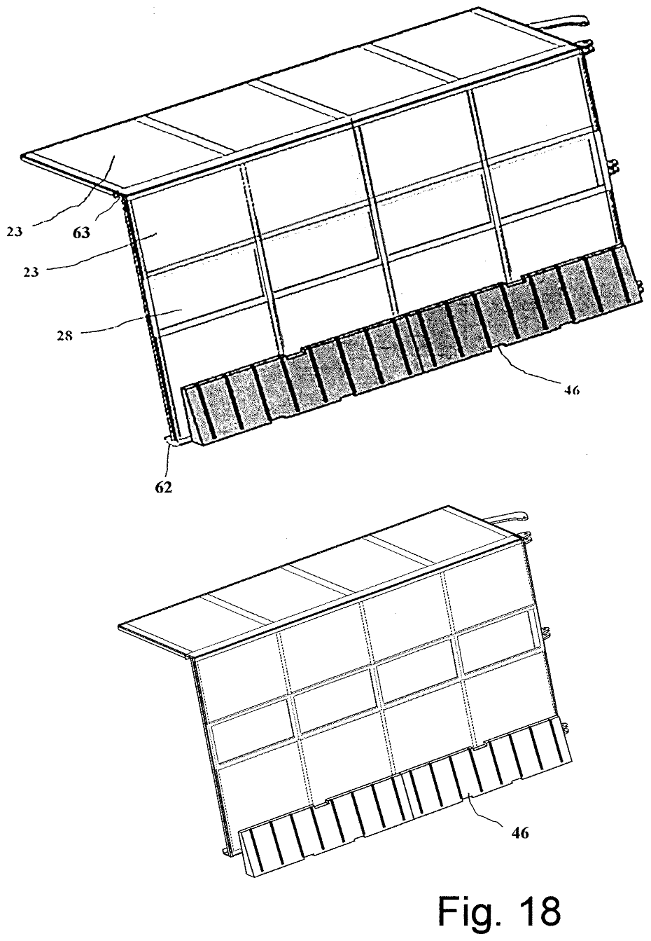

FIG. 18 shows the front side of the base wall portion 23 and the roof portion 23a with plexiglass or bullet proof windows 28 and bumper 46 attached to the face of barrier 23. The bumper 46 can be raised when transported (as shown in the top image) or lowered to ground elevation (as shown in the bottom image) when set up to block protestors—to keep rocks, frozen bottles, gasoline bombs, etc. from being thrown under the barrier. The barriers can help nudge protestors when the barriers are move forward to help move protestors back. Within the face of the barriers 23 and 25 on right and barriers 27 and 29 on left, lights, speakers, and spray nozzles (not illustrated) can be embedded as specified by the user. Also, where lawful, optional “cattle fence” shock wiring can be attached to the face of the barriers and/or bumpers and front of the vehicle our system is attached to.

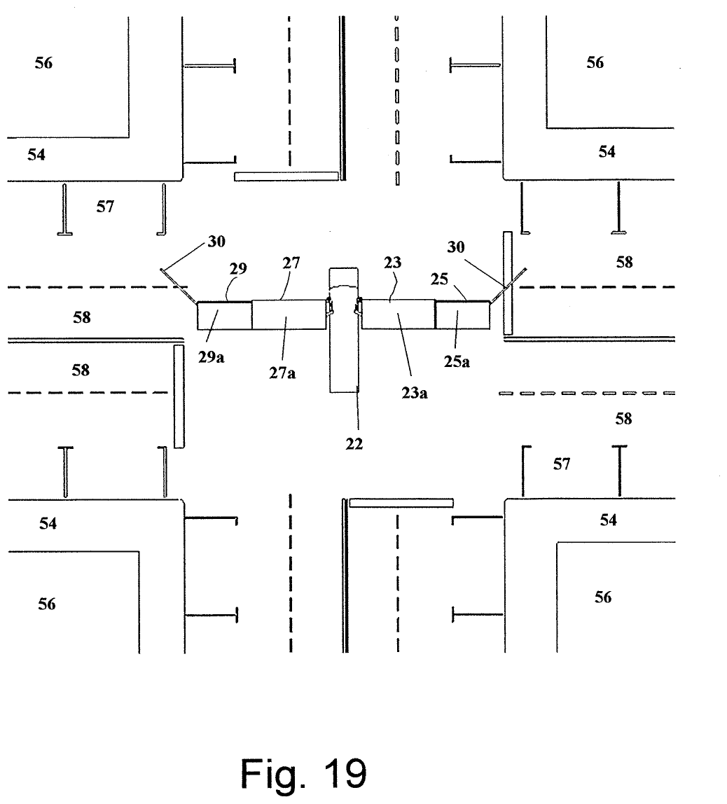

FIG. 19 shows a typical major intersection in a city showing sidewalks 54, parking lanes 57, and two thru lanes 58 in either direction, surrounded by buildings 56, showing our barrier system expanded in intersection, attached to a bus 22, with the base wall portions 23 and 27 opened 90 degrees, the telescoping wall portions 25 and 29 extended, and the pivoting wall portions 30 opened 135 degrees. After opening fully in intersection, the total system can move forward and have wide enough barriers to pull up from corner to corner across from one sidewalk on left over to the sidewalk on right to close the street and the sidewalks, with a few officers stationed at either end—verses forty to fifty officers arm to arm who would otherwise be unprotected from rocks, frozen bottles, other debris being thrown at them.

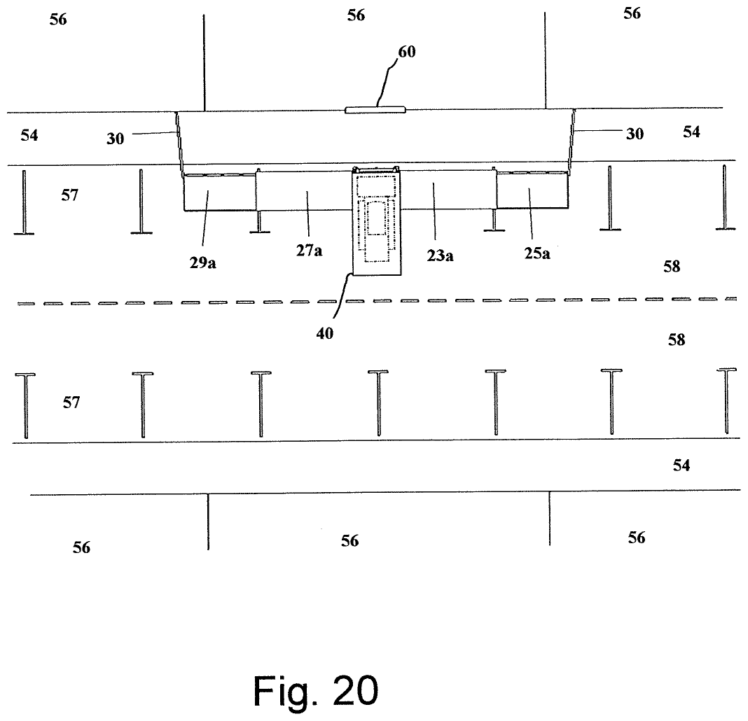

FIG. 20 shows our barrier system attached and shielding a skid steer loader 40, pulled up to sidewalk 54 curb, with the base wall portions 23 and 27 opened 90 degrees, the telescoping wall portions 25 and 29 extended, and the pivoting wall portions 30 on left and right swung open against the storefront face of buildings 56, and protecting the store entrance 60, after or before being breached by looters, and possibly containing looters already in store until police arrive. The system is sitting in parking lane 57 with thru lanes 58 behind. If sidewalk has no obstacles (light poles, fire hydrants, etc.) our system 40 can crawl or drive up on sidewalk 54, pull over to the face of building 56, pivot swinging barriers 30 back to 90 degrees and cover a longer distance along face of building 56.

In use, with a deployable crowd control barrier of embodiments of the invention attached to a bus, truck or van, the unit, with officers potentially onboard, pulls up to an intersection the officers want to block, the driver stops, starts opening his right barrier, and/or left if area wide enough, as officers are exiting the bus from rear. The driver can illuminate the area in front with lights, and, using his speakers, warn protesters to stay back, as he opens the base wall portions to the desired angle and extends the telescoping wall portions as desired.

If protestors get too close to the barrier, the officer via the speakers may warn them to back off. There may be warnings posted on the face of the barriers warning them to stay back as they may touch “shock” producing areas if they get too close. They may also be warned by both warnings posted on the face of the barrier, and verbally over speakers, that they may be subject to being sprayed by water, foul odors, or even tear gas, if those options were onboard and ordered by the police force.

The area may be lighted by bright flood lights and spotlights at elevation above the crowd. The officer inside at control booth if cameras and video cameras may let crowd know they are being filmed if that option is ordered by the law enforcement agency.

If needed, the whole unit, with barriers opened and extended, can move forward or in reverse, to move the crowd, with the officers giving voice commands and warning if they did not move, they could be subject to sprays and possible shock from bumper of barrier face, if equipped.

Other non-lethal weapons could be deployed by the law enforcement agency and installed by others.

Within cities, typically, an intersection may have two sidewalks at 12′ widths, two parking lanes at 12′ each, two through lanes in either direction at 12′ each for total of 96 feet. Our system attached to a truck or bus with 20′ base wall portions, plus 14′ telescoping wall portions and 10′ pivoting wall portions, on each side, equals 96 feet.

Ideal would be to have a second system set-up at the other end of the block and contain the protestors in a confined area, especially, if there were curfews in force, and violators needed to be easily arrested, or unlawful protestors contained and separated as they clear the block.

Likewise, it may be ideal to have our “Intimidator” deployed at other end of block, heading back towards this barrier, especially, if there had been violent protestors in the area, possible looting and/or fires started.

“The Intimidator” is described below. It is our mobile barrier attached to a remote-controlled equipped skid steer shielded unit.

The “Intimidator” is a unit that can be used once an area is too risky to send personal/officers/firefighters into, where protesters have become violent and started looting and starting fires.

It may have our shielded mobile barrier attached on either side front corners, still pivoting off the longer lateral sides of the vehicle, and be able to remotely open and extend the second wall—if needed to move down and clear the street. It could have our option with bumpers that are electrified.

And if a store front had already been breached, our unit could pull directly up onto a sidewalk, pulling within inches of the face of the building or if there were light poles, fire hydrants, other obstacles, just pulling to the curb, extend its walls, both left and right, swing it's ends, and protect the opening that was opened up by the looters. If looters were still inside it could contain them within until officers arrived.

The “Intimidator” could be unmanned, remote-controlled, by an officer several blocks away, sitting in a separate vehicle, where it is safe, he/they viewing the surroundings where the “Intimidator” is being moved into, it having flood lights and spot lights, remote controlled by the officer/officers several blocks away, he/they having ability to direct the spot light onto an individual looter, and having cameras and ability to video record or photograph an individual, while video recording the whole area on all sides as well, and via audio speakers—shout at individuals—letting them know they were being photographed and video recorded.

The “intimidator” may have very loud speakers, enabling the officer/officers to send out different sounds, possibly sirens or a dog barking, etc.

The “Intimidator” may be guarded by heavy plate steel or other armor so the crowd could beat on it and it take abuse and it would typically have substantial weight, not easily turned over. It may also be equipped with spray nozzles and different fluids, either water, foul odors, tear gases etc., that could be used to defend itself, keeping the crowd at bay—the officers forewarning them to not approach our unit and/or forcing them to keep moving or they may be sprayed. Warnings may be posted on the sides and front of our unit.

Our unit may need to have a fire suppression system onboard as some protestors have thrown firebombs at cars and buildings.

Another feature could be added to our “Intimidator” unit—that being high pressure water nozzles, with directional control, and having some water capacity to extinguish a small fire. Also, it could pull a small hose in or have water hose reel onboard and lay hose down moving in, picking it up as it reverses, and have pumper truck supply added water to our unit remotely, or water source hooked directly to fire hydrant and portable pump, either at hydrant or pump onboard, and have greater capacity to extinguish a larger fire.

With that water pressure ability, it could also be used against the crowd and force them to move along away from the area—so officers could go in and secure it.

If either a water pumper or hydrants are not available, we may provide option to provide water tank on trailer, which our unit may pull in, having enough water to spray protestors to make them move and/or put out fires.

We feel the combination of strong lights, cameras recording them, an officer pinpointing individuals, and loud commands coming from a heavily fortified unit—unmanned—that could spray water, skunk or sulfur smell initially, possibly tear gas it that did not work, and had barriers to widen out possibly street wide—moving at them, would help clear streets that had been too risky in past to enter and control. Once people moved, it could address fires and, if necessary, pull up to a building and extend its barrier walls and protect an opened, breached storefront.

Several units could be deployed at either end of a block and via the cameras and lighting pick out any aggressive unlawful violators and pick them out as they pass by the ends of our units when they try to exit those blocks.

We believe a very suitable vehicle for our “Intimidator” for mobility of our system would be a common skid steer loader, either wheeled or tracked, already remote ready. The system can be designed and built so that the standard skid steer could pull into our shielded box, connect at the front by their quick attach standard hook-up points, add quick attach and detach brackets at rear so the skid steer could drive out from under our system and be used for other purposes when not needed for crowd control, possibly snow removal or grass cutting as examples.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below (if any) are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A deployable crowd control barrier comprising:
a first barrier wall adapted to be affixed to a vehicle, the first barrier wall comprising a first vertical pivot post adapted to be pivotably affixed to the vehicle and a first base wall portion affixed to the first pivot post; and
a second barrier wall adapted to be affixed to the vehicle on an opposite side from the first barrier wall, the second barrier wall comprising a second vertical pivot post adapted to be pivotably affixed to the vehicle and a second base wall portion affixed to the second pivot post;
wherein the first base wall portion is adapted to selectively pivot relative to the vehicle when the first barrier wall is affixed to the vehicle; and
wherein the second base wall portion is adapted to selectively pivot relative to the vehicle when the second barrier wall is affixed to the vehicle.

2. The deployable crowd control barrier of claim 1, wherein the first base wall portion is adapted to selectively pivot from an undeployed position abutting a first side of the vehicle to a deployed position that is pivoted up to 180 degrees from its undeployed position; and
wherein the second base wall portion is adapted to selectively pivot from an undeployed position abutting a second side of the vehicle to a deployed position that is pivoted up to 180 degrees from its undeployed position.

3. The deployable crowd control barrier of claim 1, wherein the first barrier wall further comprises a first telescoping wall portion affixed to and selectively slidably extendible from the first base wall portion; and
wherein the second barrier wall further comprises a second telescoping wall portion affixed to and selectively slidably extendible from the second base wall portion.

4. The deployable crowd control barrier of claim 3, wherein the first barrier wall further comprises a first pivoting wall portion pivotably affixed to and selectively pivotable relative to a distal end of the first telescoping wall portion; and
wherein the second barrier wall further comprises a second pivoting wall portion pivotably affixed to and selectively pivotable relative to a distal end of the second telescoping wall portion.

5. The deployable crowd control barrier of claim 3, wherein the first telescoping wall portion comprises (a) a plurality of top casters affixed along a top edge of the first telescoping wall portion and engageable with a top track affixed at a top edge of the first base portion and (b) a plurality of bottom casters affixed along a bottom edge of the first telescoping wall portion and engageable with a bottom track affixed at a bottom edge of the first base portion; and
wherein the second telescoping wall portion comprises (a) a plurality of top casters affixed along a top edge of the second telescoping wall portion and engageable with a top track affixed at a top edge of the second base portion and (b) a plurality of bottom casters affixed along a bottom edge of the second telescoping wall portion and engageable with a bottom track affixed at a bottom edge of the second base portion.

6. The deployable crowd control barrier of claim 3, further comprising:
a first roof portion extending at an angle from a top edge of the first base portion; and
a second roof portion extending at an angle from a top edge of the second base portion.

7. The deployable crowd control barrier of claim 6, further comprising:
a third roof portion extending at an angle from a top edge of the first telescoping wall portion; and
a fourth roof portion extending at an angle from a top edge of the second telescoping wall portion.

8. The deployable crowd control barrier of claim 7, wherein the first roof portion and the third roof portion are nested when the first telescoping wall portion is not slidably extended from the first base wall portion; and
wherein the second roof portion and the fourth roof portion are nested when the second telescoping wall portion is not slidably extended from the second base wall portion.

9. The deployable crowd control barrier of claim 1, wherein the first base wall portion comprises a movable bumper selectively movable downward to a position extending below a bottom edge of the first base wall portion and upward to a position not extending below a bottom edge of the first base wall portion; and
wherein the second base wall portion comprises a movable bumper selectively movable downward to a position extending below a bottom edge of the second base wall portion and upward to a position not extending below a bottom edge of the second base wall portion.

10. The deployable crowd control barrier of claim 1, further comprising:
a first supporting cable affixed at a proximal end to the pivot post and at a distal end to a distal end of the first base wall portion; and
a second supporting cable affixed at a proximal end to the pivot post and at a distal end to a distal end of the second base wall portion.

11. A crowd control vehicle comprising:
a vehicle body having a first side and an opposing second side; and
a deployable crowd control barrier comprising:
a first barrier wall affixed to the vehicle, the first barrier wall comprising a first vertical pivot post pivotably affixed to the vehicle and a first base wall portion affixed to the first pivot post; and
a second barrier wall affixed to the vehicle, the second barrier wall comprising a second vertical pivot post pivotably affixed to the vehicle and a second base wall portion affixed to the second pivot post;
wherein the first base wall portion is selectively pivotable relative to the first side of the vehicle body; and
wherein the second base wall portion is selectively pivotable relative to the second side of the vehicle body.

12. The crowd control vehicle of claim 11, wherein the first base wall portion is selectively pivotable from an undeployed position abutting the first side of the vehicle body to a deployed position that is pivoted up to 180 degrees from its undeployed position; and
wherein the second base wall portion is adapted to selectively pivot from an undeployed position abutting the second side of the vehicle body to a deployed position that is pivoted up to 180 degrees from its undeployed position.

13. The crowd control vehicle of claim 11, wherein the first barrier wall further comprises a first telescoping wall portion affixed to and selectively slidably extendible from the first base wall portion; and
wherein the second barrier wall further comprises a second telescoping wall portion affixed to and selectively slidably extendible from the second base wall portion.

14. The crowd control vehicle of claim 13, wherein the first barrier wall further comprises a first pivoting wall portion pivotably affixed to and selectively pivotable relative to a distal end of the first telescoping wall portion; and
wherein the second barrier wall further comprises a second pivoting wall portion pivotably affixed to and selectively pivotable relative to a distal end of the second telescoping wall portion.

15. The crowd control vehicle of claim 13, wherein the first telescoping wall portion comprises (a) a plurality of top casters affixed along a top edge of the first telescoping wall portion and engageable with a top track affixed at a top edge of the first base portion and (b) a plurality of bottom casters affixed along a bottom edge of the first telescoping wall portion and engageable with a bottom track affixed at a bottom edge of the first base portion; and
wherein the second telescoping wall portion comprises (a) a plurality of top casters affixed along a top edge of the second telescoping wall portion and engageable with a top track affixed at a top edge of the second base portion and (b) a plurality of bottom casters affixed along a bottom edge of the second telescoping wall portion and engageable with a bottom track affixed at a bottom edge of the second base portion.

16. The crowd control vehicle of claim 13, further comprising:
a first roof portion extending at an angle from the top edge of the first base portion; and
a second roof portion extending at an angle from the top edge of the second base portion.

17. The crowd control vehicle of claim 16, further comprising:
a third roof portion extending at an angle from the top edge of the first telescoping wall portion; and
a fourth roof portion extending at an angle from the top edge of the second telescoping wall portion.

18. The crowd control vehicle of claim 71, wherein the first roof portion and the third roof portion are nested when the first telescoping wall portion is not slidably extended from the first base wall portion; and
wherein the second roof portion and the fourth roof portion are nested when the second telescoping wall portion is not slidably extended from the second base wall portion.

19. The crowd control vehicle of claim 11, wherein the first base wall portion comprises a movable bumper selectively movable downward to a position extending below a bottom edge of the first base wall portion and upward to a position not extending below a bottom edge of the first base wall portion; and
wherein the second base wall portion comprises a movable bumper selectively movable downward to a position extending below a bottom edge of the second base wall portion and upward to a position not extending below a bottom edge of the second base wall portion.

20. The crowd control vehicle of claim 11, further comprising:
a first supporting cable affixed at a proximal end to the pivot post and at a distal end to a distal end of the first base wall portion; and
a second supporting cable affixed at a proximal end to the pivot post and at a distal end to a distal end of the second base wall portion.
